(19) United States
(12) Patent Application Publication
(10) Pub. No.: US 2021/0372461 A1
(43) Pub. Date: Dec. 2, 2021

(54) FISHING ROD WITH UTILITY CLIP

(71) Applicant: W.C. BRADLEY/ZEBCO HOLDINGS, INC., TULSA, OK (US)

(72) Inventors: CLARK PATRICK McCUNE, Roanoke, TX (US); CHRISTOPHER S. LITTAU, Bartlesville, OK (US); SHANE FETTY, Jenks, OK (US); ZU HANG FANG, Jiangsu (CN)

(21) Appl. No.: 16/888,332

(22) Filed: May 29, 2020

(51) Int. Cl. F16B 45/02; A01K 87/00

(52) U.S. Cl. CPC F16B 45/02; A01K 87/00

(57) ABSTRACT

A fishing rod is provided with a handle defining a receiving area. A selectively closable latch member allows for quick attachment and release from a carrying member, such as a loop on a backpack, a tackle box receptacle, towel, or other object or point of attachment. The receiving area is partially defined by an inside surface of the handle. A gap is defined by a first surface on a latch receiving portion and a second surface on a latch mount portion. A latch member is mounted on the latch mount portion for selectively obstructing the gap. The latch member may be biased towards a closed position and may have a long side and a short side for biasing the latch member towards the closed position.

### FIELD OF THE INVENTION

The present invention relates to fishing rods. More particularly, the invention relates to a handle of a fishing rod having a device for facilitating easy transport.

### BACKGROUND OF THE INVENTION

Recreational fishing is commonly practiced with a rod, reel, line, hooks and any one of a wide range of baits. Weights, floats, and swivels may also be utilized. Lures are frequently used in place of bait. The practice of catching or attempting to catch fish with a hook is known as angling.

A rod and reel and associated gear must be transported to a fishing location. If combined with gear for backpacking or camping, a fisherman may experience difficulties with transporting the necessary equipment. Rods and reels may be especially problematic due to their length and snagging potential when the rod and reel is transported in a fishing-ready configuration.

It is, therefore, desirable to provide a fishing rod and reel that facilitates ease of transport, including easy attachment to a backpack or other object.

### SUMMARY OF THE INVENTION

A fishing rod and reel of the invention is provided with a handle that defines a receiving area and a pivotally mounted latch member for quick attachment and release from a carrying member, such as a loop on a backpack, or other point of attachment.

The fishing rod of the invention has a handle having a reel mount portion and a grip portion. The grip portion has an inside end and an outside end, a top side, a bottom side, a first side and a second side. The inside end of the grip portion is adjacent to the reel mount portion. A rod is affixed to the first end of the reel mount portion.

The handle defines a terminal portion at the outside end of the grip portion. The terminal portion has an outside surface, an inside surface, and defines a latch receiving portion. The latch receiving portion terminates at an outside open surface. The latch receiving portion defines a receiving groove that extends from the first side of the grip portion to the second side of the grip portion.

The grip portion defines a latch mount having an inside open surface. The latch mount defines a first latch orifice and a second latch orifice. The first latch orifice is a first distance from the receiving groove and the second latch orifice is a second distance from the receiving groove.

The outside open surface of the latch receiving portion and the inside open surface of the latch mount define a gap therebetween. The grip portion defines an open area adjacent the outside end of the handle. The open area is bounded by an inside surface and the gap.

In one embodiment, a latch member is rotatably mounted in the latch mount and located to span the gap. The latch member is preferably constructed of a single wire. The latch member preferably has an asymmetrical shape with a first end and a second end, a short side, a long side. A latching portion of the latch member is between the short side and the long side. The first end is received in the first latch orifice of the latch mount while the second end received in the second latch orifice of the latch mount. The latching portion is received in the receiving groove defined by the latch receiving portion. In other embodiments, the latch member may be a threaded cylinder, spring biased flat stock, a spring biased rod, etc.

The latch member is movable from a closed position to an open position. In one embodiment, when the latch member is in the closed position the latching portion is received in the receiving groove. When the latch member is in the open position the latching portion traverses the open area such that the latching portion is proximate the terminal portion, thereby allowing objects to traverse the gap.

In the wire embodiment, the short side of the latch member defines an angle α1 between the closed position and the open position of the latch member. The long side of the latch member defines an angle α₂ between the closed position and the open position of the latch member. In one embodiment, angle α₁ is less than angle α₂. In one embodiment, the asymmetrical shape of the latch member results in the latch member biasing towards the closed position.

### BRIEF DESCRIPTION OF THE DRAWINGS

FIG. 1 is an elevation view of a rod and reel having a handle.

FIG. 2 is an enlarged plan view of a bottom of the handle of FIG. 1.

FIG. 3 is an enlarged elevation view of an end of the handle of FIG. 1 showing a latch member in a closed position.

FIG. 4 is an enlarged elevation view of an end of the handle of FIG. 1 showing the latch member in an open position.

FIG. 5 is a cross-sectional view of the handle of FIG. 3 taken along line 5-5 of FIG. 3.

FIG. 6 is a plan view of the latch member of FIGS. 1-5.

FIG. 7 is an elevation view of the latch member is FIGS. 1-6.

FIG. 8 is an enlarged view of an outside end of the handle of FIGS. 1-4 showing the latch pivotally mounted therein.

### DETAILED DESCRIPTION OF THE PREFERRED EMBODIMENTS

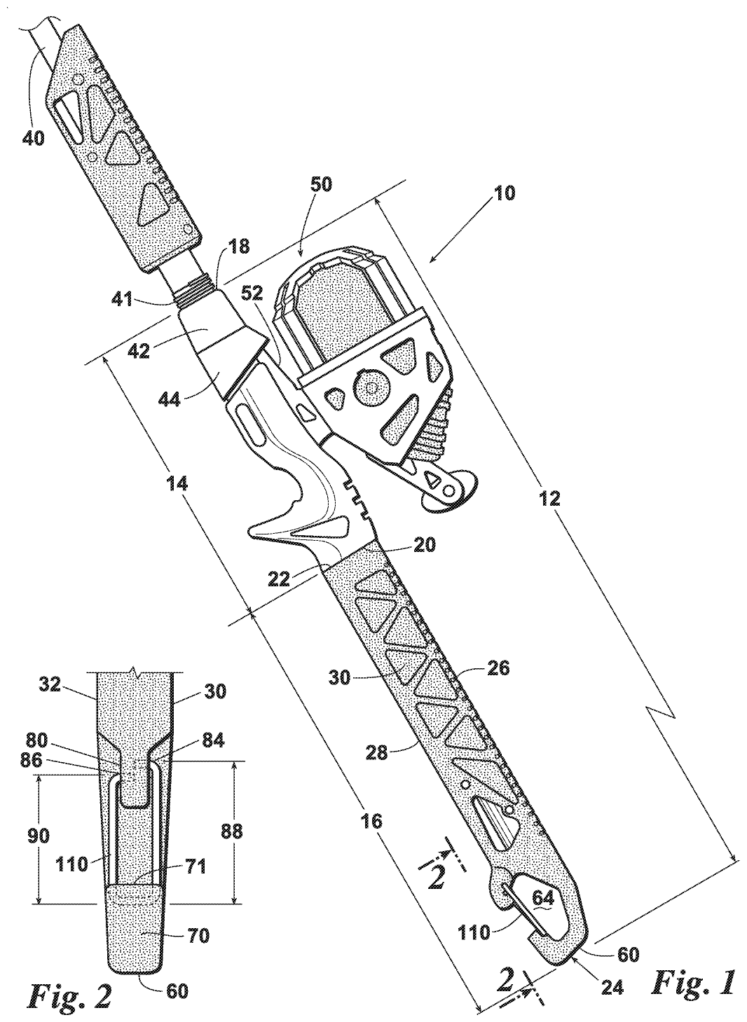

Referring to FIGS. 1-8, shown is fishing rod, designated generally 10. Fishing rod 10 includes handle 12. Handle 12 has reel mount portion 14 and grip portion 16. Reel mount portion 14 has first end 18 and second end 20. Grip portion 16 has inside end 22, outside end 24, top side 26, bottom side 28, first side 30, and second side 32 (FIGS. 2-4). Inside end 22 of grip portion 16 is adjacent second end 20 of reel mount portion 14.

Rod 40 is affixed to first end 18 of reel mount portion 14. Rod 40 defines threads 41. Securing nut 42 is threadably received on threads 41 at first end 18 of reel mount portion 14. Securing nut 42 slidably positions reel foot receiver 44.

Reel 50 has reel foot 52 received on reel mount portion 14. Reel foot 52 is secured in reel mount portion 14 with reel foot receiver 44 and securing nut 42.

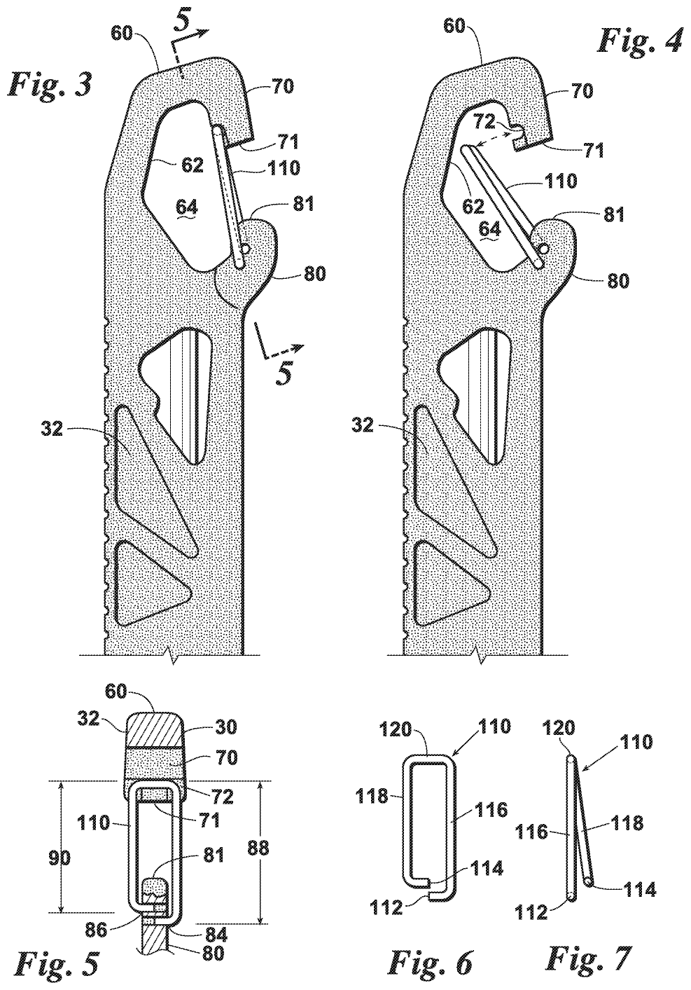

Grip portion 16 of handle 12 defines terminal portion 60 at outside end 24. Terminal portion 60 defines a length of inside surface 62 (FIGS. 3, 4, 8) that defines receiving area 64. Terminal portion 60 defines latch receiving portion 70 (FIGS. 2-5 and 8) defining an outside gap facing surface 71. Terminal portion 60 and latch receiving portion 70 define a hook shape that partially surrounds receiving area 64. Latch receiving portion 70 defines receiving groove 72 (FIGS. 4, 5). Receiving groove 72 extends from first side 30 of grip portion 16 to second side 32 of grip portion 16.

Grip portion 16 defines latch mount portion 80 (FIGS. 2, 3, 8). Latch mount portion 80 has an inside gap facing surface 81 (FIGS. 3-5, 8). Latch mount portion 80 defines first latch orifice 84 and second latch orifice 86 (FIGS. 2, 5). First latch orifice 84 is first distance 88 from receiving groove 72. Second latch orifice 86 is second distance 90 from receiving groove 72 (FIGS. 2, 5).

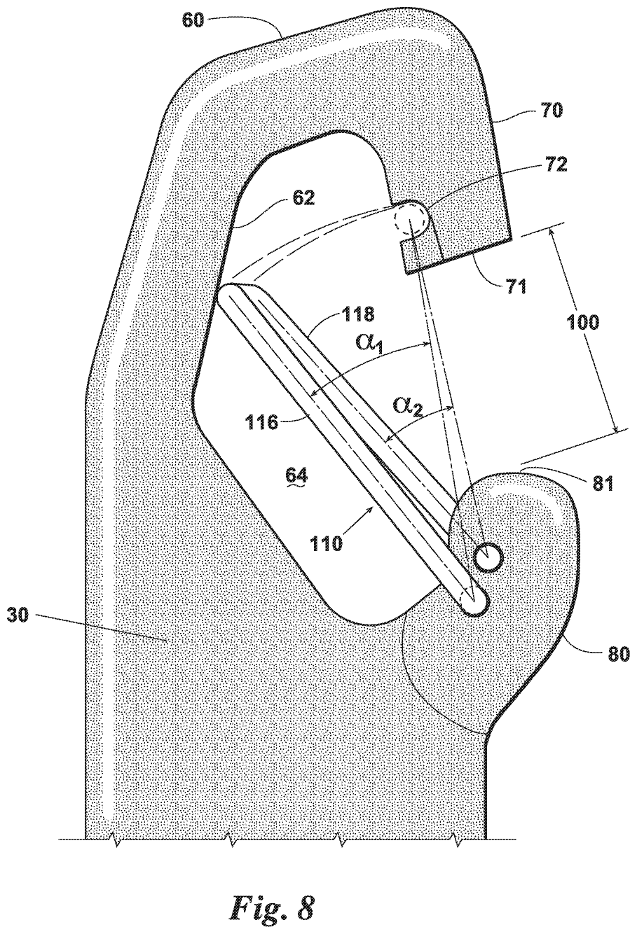

Outside gap facing surface 71 of latch receiving portion 70 and inside gap facing surface 81 of latch mount portion 80 define gap 100 therebetween (FIG. 8).

In one embodiment, latch member 110 is rotatably mounted to latch mount portion 80. Latch member 110 is located to span gap 100 (FIG. 8). Latch member 110 is preferably constructed of a single wire. Latch member 110 has an asymmetrical shape. In greater detail, as best seen in FIGS. 6 and 7, latch member 110 defines first end 112, second end 114, long side 116, short side 118, and latching portion 120 between long side 116 and short side 118. First end 112 is received in first latch orifice 84 of latch mount portion 80. Second end 114 is received in second latch orifice 86 of latch mount 80. Latching portion 120 is received in receiving groove 72 defined by latch receiving portion 70. Latch member 110 is movable from a closed position (FIG. 3) to an open position (FIG. 4). When latch member 110 is in the closed position, latching portion 120 is received in receiving groove 72. When latch member 110 is in an open position, latching portion 120 swings into open area 64 such that latching portion 120 is proximate inside surface 62, thereby allowing objects to traverse gap 100. In other embodiments, the latch member may be a threaded cylinder, spring biased flat stock, spring biased rod, etc. The latch member is a movable structure provided for selectively assuming an open position and a closed position.

Referring now to FIG. 8, when long side 116 of latch member 110 defines an angle α₁ between the closed position and the open position of latch member 110, short side 118 of latch member 110 defines an angle α₂ between the first position and second position of latch member 110. In one embodiment, angle α₁ is greater than the angle α₂. The asymmetrical shape of latch member 110 results in latch member 110 being biased towards the closed position.

Although particular embodiments have been described herein, it will be appreciated that the invention is not limited thereto and that many modifications and additions thereto may be made within the scope of the invention. For example, various combinations of the features of the following dependent claims can be made with the features of the independent claims without departing from the scope of the present invention.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A fishing rod comprising:
a handle defining a receiving area, said receiving area partially defined by an inside surface, said handle defining a latch receiving portion and a latch mount portion, said latch receiving portion defining a first surface said latch mount portion defining a second surface;
wherein said first surface and said second surface define a gap therebetween;
a latch member on said latch mount portion for selectively obstructing said gap.

2. The fishing rod according to claim 1 wherein:
said latch member is pivotally mounted on said latch mount portion.

3. The fishing rod according to claim 1 wherein:
said latch member is biased towards a closed position.

4. The fishing rod according to claim 3 wherein:
said latch member has a long side and a short side;
wherein said long side has a greater length than said short side for biasing said latch member towards said closed position.

5. The fishing rod according to claim 4 wherein:
an angle α₁ is an angle between said long side when said latch member is in an open position and said long side when said latch member is in said closed position;
an angle α₂ is an angle between said short side when said latch member is in said open position and said short side when said latch member is in said closed position;
wherein said angle α₁ is greater than said angle α₂.

6. The fishing rod according to claim 1 wherein:
said latch member is constructed of a single piece of wire.

7. The fishing rod according to claim 1 wherein:
latch receiving portion defines a receiving groove for receiving a portion of said latch member.

8. A method of carrying a fishing rod comprising:
manipulating a latch member that spans a gap for moving said latch member to an open position for providing access to a receiving area defined by a handle of the fishing rod;
inserting an object into said a receiving area;
manipulating said latch member to a closed position for restricting access through said gap to said receiving area for trapping the object in said receiving area for permitting said handle of said fishing rod to be affixed to said object for transport.

9. The method according to claim 8 wherein:
said latch member is biased towards a closed position.

10. The fishing rod according to claim 8 wherein:
said latch member has a long side and a short side;
wherein said long side has a greater length than said short side for biasing said latch member towards said closed position.

11. The fishing rod according to claim 10 wherein:
an angle α₁ is an angle between said long side when said latch member is in said open position and said long side when said latch member is in said closed position;
an angle α₂ is an angle between said short side when said latch member is in said open position and said short side when said latch member is in said closed position;
wherein said angle α₁ is greater than said angle α₂.

12. The fishing rod according to claim 8 wherein:
said latch member is constructed of a single piece of wire.

13. The fishing rod according to claim 8 wherein:
a latch receiving portion receives a portion of said latch member in a receiving groove when said latch member is in said closed position.
